(19) United States
(12) Patent Application Publication
(10) Pub. No.: US 2015/0026652 A1
(43) Pub. Date: Jan. 22, 2015

(54) SYSTEM, METHOD, AND COMPUTER PROGRAM PRODUCT FOR CORRELATING TRANSACTIONS WITHIN A SIMULATION OF A HARDWARE PLATFORM FOR POST-SIMULATION DEBUGGING

(71) Applicant: NVIDIA Corporation, Santa Clara, CA (US)

(72) Inventors: Brian Scott Pharris, Cary, NC (US); Saad Iqbal Godil, Sunnyvale, CA (US)

(21) Appl. No.: 13/945,829

(22) Filed: Jul. 18, 2013

(51) Int. Cl. G06F 17/50

(52) U.S. Cl. CPC G06F 17/5022
USPC 716/106

(57) ABSTRACT

A system, method, and computer program product for correlating transaction within a simulation of a hardware platform for post-simulation debugging is disclosed. The method includes the steps of initializing state information associated with a hardware simulation for a register-transfer level model representing a digital circuit design, executing the hardware simulation to generate a simulation output, generating one or more transaction objects based on the signals in the simulation output, and correlating a first transaction object of the one or more transaction objects with a second transaction object of the one or more transaction objects based on a set of rules and a state model.

### FIELD OF THE INVENTION

The present invention relates to electronic design, and more particularly to debugging of hardware simulation waveforms.

### BACKGROUND

Conventional hardware design often involves the step of designing and verification of digital circuits at the register-transfer level (RTL) of abstraction, The designer develops code to model the digital circuits using a hardware description language such as Verilog. The code may be simulated to debug the operation of the digital circuit during a design. The output of the simulation may be a set of waveforms associated with corresponding nets (i.e., wires).

In very large designs, such as designs for portions of a graphics processing unit (GPU), debugging a series of waveforms may be extremely difficult. A single transaction e.g., signal input) may be transmitted to a large number of components within the design, propagating across a number of different interfaces between components before a failure is realized at one or more components. Furthermore, a single transaction may be interleaved among many different transactions at each interface. For example, a memory read request must be matched against a corresponding response from the memory unit in order to debug issues with the design. The memory read request may be transmitted to the memory subunit many clock cycles before the corresponding response is received from the memory unit, with tens or even hundreds of intervening responses received from the memory unit in between the request and the corresponding response. In addition, in more complicated cases, a single element in the design may be related to a large number of transactions across many interfaces substantially simultaneously.

Debugging failures in the digital circuit design may be very difficult as a designer must look at the waveforms of a large number of nets across a large amount of time during the simulation in order to pinpoint the likely causes of failure. There is no mechanism to relate signals at one interface to signals at another interface as being related to the same transaction or set of transactions and quickly identify such signals as being related. Thus, the designer must manually search through hundreds or thousands of waveforms in order to debug the causes of such failures. Thus, there is a need for addressing this issue and/or other issues associated with the prior art.

### SUMMARY

A system, method, and computer program product for correlating transactions within a simulation of a hardware platform for post-simulation debugging is disclosed. The method includes the steps of initializing state information associated with a hardware simulation for a register-transfer level model representing a digital circuit design, executing the hardware simulation to generate a simulation output, generating one or more transaction objects based on the simulation output, and correlating a first transaction object of the one or more transaction objects with a second transaction object of the one or more transaction objects based on a set of rules and a state model.

### BRIEF DESCRIPTION OF THE DRAWINGS

FIG. 1 illustrates a flowchart of a method for correlating transactions within a simulation of a hardware design, in accordance with one embodiment;

FIG. 2 illustrates a conceptual diagram of a hardware design flow, in accordance with one embodiment;

FIG. 3 illustrates a system that implements at least a portion of the simulation stage in the design flow, in accordance with one embodiment;

FIG. 4 is a conceptual illustration of the operation of the transaction processor of FIG. 3, in accordance with one embodiment;

FIG. 5 illustrates a flowchart of a method for correlating transactions within a simulation of a hardware design, in accordance with another embodiment; and

FIG. 6 illustrates an exemplary system in which the various architecture and/or functionality of the various previous embodiments may be implemented.

### DETAILED DESCRIPTION

The present disclosure describes a mechanism for performing automated analysis of waveform output from conventional simulation of RTL hardware designs. A simulation is run in order to generate a waveform output. In other words, the simulation generates a set of waveforms based on a vector input, where the set of waveforms includes a single waveform for each net described by the RTL hardware design. The waveform output is analyzed by a transaction extractor to generate a list of transactions. The list of transactions is analyzed by a transaction processor to generate a set of processed transactions that are compatible with a transaction viewer. The designer may then analyze the set of processed transactions with the transaction viewer. The transaction viewer allows the designer to filter the portions of the waveforms based on particular transactions as well as based on other criteria. This filtering enables a designer to more easily pinpoint issues with the design of the digital circuit. The above features may or may not be exploited in the context of the various embodiments set forth below.

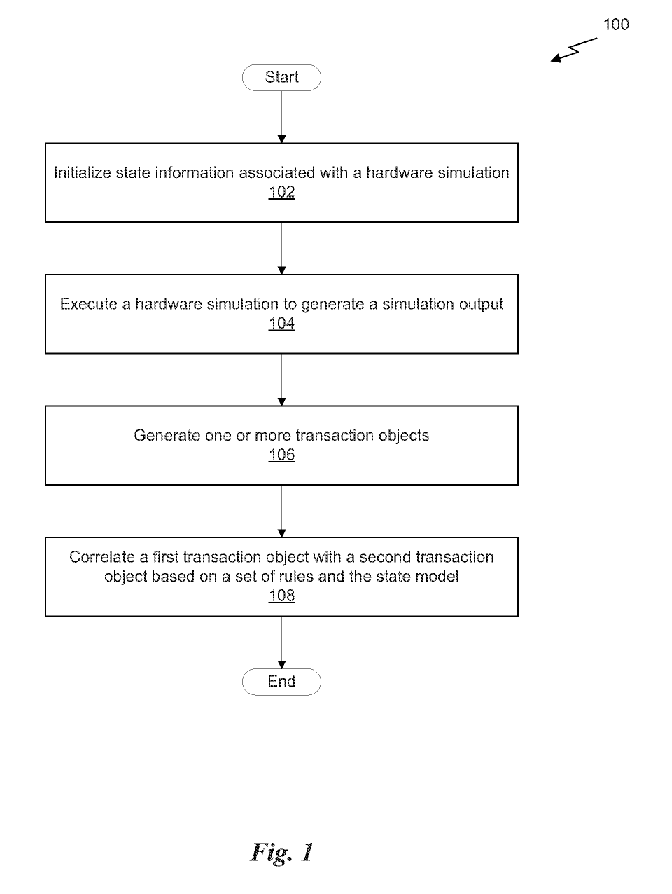

FIG. 1 illustrates a flowchart of a method 100 for correlating transactions within a simulation of a hardware design, in accordance with one embodiment. At step 102, state information associated with a hardware simulation for an RTL model for a digital circuit design is initialized. In the context of the present description, the RTL model is code for representing the digital circuit in a hardware description language such as Verilog or VHDL. At step 104, the hardware simulation is executed to generate a simulation output. In some possible embodiments, the simulation output is a set of one or more waveforms for at least a portion of the nets defined in the RTL model. At step 106, one or more transaction objects are generated. The transaction objects are data structures that store state information associated with a transaction on the simulated digital circuit. In the context of the present description, the transaction objects may be generated in response to an analysis of the signals included in the simulation output. At step 108, a first transaction object is correlated with a second transaction object based on a set of rules and a state model.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

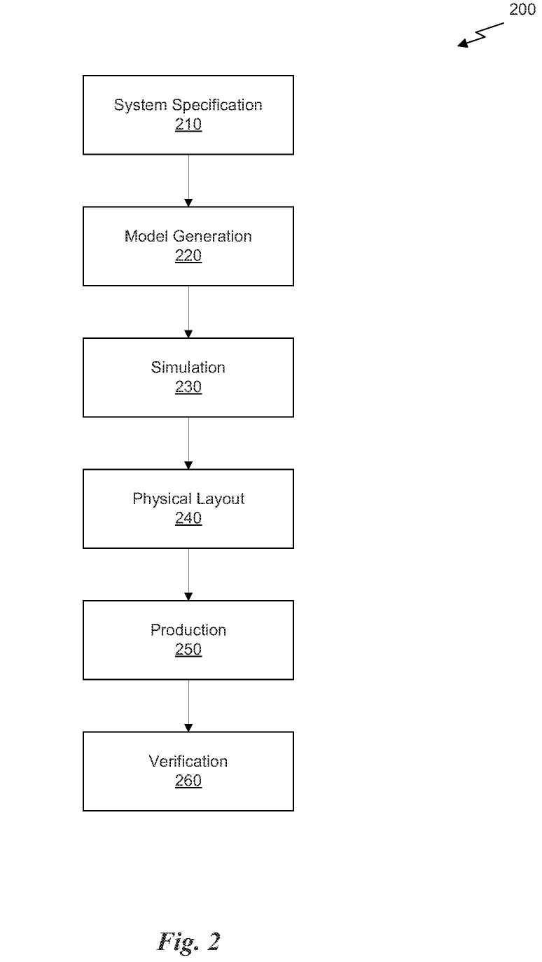

FIG. 2 illustrates a conceptual diagram of a hardware design flow 200, in accordance with one embodiment. As shown in FIG. 2, the hardware design flow 200 starts with a system specification stage 210. At this stage of the design flow 200, the designers generate an architectural specification for the hardware that specifies the desired function of the digital circuit using a high-level of abstraction. Once the designers have settled on an architectural specification for the digital circuit, the next stage of the design flow 200 is the model generation stage 220 where the designer generates an RTL model for the digital circuit. In one embodiment, the RTL model for the digital circuit is a file that includes code in a hardware description language that describes synchronous circuits in the digital circuit using basic combinational logic and registers. The abstraction level is typically above the level of a transistor level design or logic gate design. In one embodiment, the RTL model may be generated automatically from the architectural specification for the digital circuit such as by converting an abstract specification written in the C or C++ programming languages to an RTL modeln in, e.g., a hardware description language such as Verilog or VHDL. In another embodiment, the RTL model may be created manually in the hardware description language by a designer. It will be appreciated that one or more intermediate models may also be generated in the model generation stage that each has a level of abstraction between the architectural specification and the RTL model.

Once the RTL model has been created, the design flow 200 includes a simulation stage 230. During the simulation stage 230, one or more logic simulation tools may be used to verify the operation of the digital circuit described by the RTL model. Conventional simulation software such as Synopsys' VCS (Verilog compiled code simulator) tool or Cadence's Incisive Enterprise Simulator may be used to simulate digital circuits using the RTL model. Once the designer has verified operation of the components using the RTL model, the design flow 200 moves into a physical layout stage 240 where the RTL model is synthesized to map the RTL model onto a gate-level netlist in the target technology for the digital circuit. The gates in the netlist are placed on non-overlapping areas of the physical die. Clock trees and routing of interconnects may be made between the logical components. The physical design may be optimized at this time by analyzing lengths of interconnects, signal fanout, etc., and adjustments to the physical design of the digital circuit may he effectuated. Additional optimizations may he made to the design and the design may be checked to search for any additional errors. The design flow 200 moves onto a production stage 250 where tapeout and mask generation are performed and the digital circuit is manufactured on silicon wafers. After the die have been produced, the design flow 200 includes a verification stage 260 where the physical die are subjected to various functionality testing and validation. Once validation is complete, the die may be packaged and entered into the market.

It will he appreciated that the design flow 200 in FIG. 2 is only one example of a design flow implemented for a digital circuit. Each manufacturer of digital circuits may implement different design flows having a different number of stages, including additional stages for testing and verification, feedback paths, etc. Other types of design flow are contemplated as being within the scope of the present disclosure.

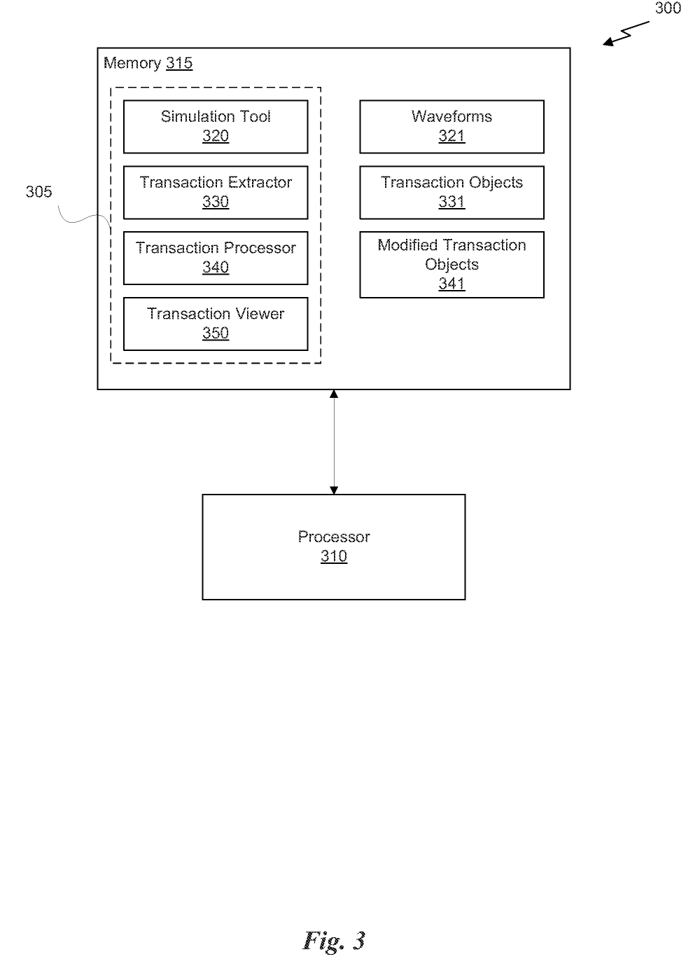

FIG. 3 illustrates a system 300 that implements at least a portion of the simulation stage 230 in the design flow 200, in accordance with one embodiment. As shown in FIG. 3, the system 300 includes a processor 310 and a memory 315. A set of tools 305 (i.e., programs), including a simulation tool 320, a transaction extractor 330, a transaction processor 340, and a transaction viewer 350, are stored in the memory 315 and configured to be executed by the processor 310. In various embodiments, the system 300 may be implemented using a desktop computer, a laptop computer, a thin client coupled to a server computer located on a network, or any other electronic component configured to execute at least one of the simulation tool 320, the transaction extractor 330, the transaction processor 340, or the transaction viewer 350.

One or more of the tools 305 may be a custom designed software program developed in conjunction with the RTL model to generate supplemental data for use during debugging. For example, the translation extractor 330 may be configured to analyze a set of waveforms 321 generated by the simulation tool 320 to generate basic data structures for storing transaction objects 331. The translation extractor 330 may be configured to monitor a particular signal on an interface (i.e., a particular signal of one or more waveforms in the set of waveforms 321) to detect when a transaction is initiated, In one embodiment, when the translation extractor 320 detects the conditions for the initiation of a transaction, then the translation extractor 320 generates a transaction object 331 and stores the transaction object 331 in the memory 315. The particular conditions and signals necessary to generate a transaction object 331 are determined by the designer based on the design of the RTL model. Similarly, the transaction processor 340 and the transaction viewer 350 may also be designed based on, at least in part, the configuration of the RTL model.

In one embodiment, the simulation tool 320 is a general purpose circuit simulation program. The simulation tool 320 may include a transaction level simulator that verifies the function of the RTL code and a timing analysis tool to verify the timing the signals included in the netlist. The transaction level simulator may be configured to generate the set of waveforms 321. In other embodiments, the simulation tool 320 may be any program configured to perform circuit simulation by analyzing an RTL model and generating a set of waveforms based on a set of input vectors. The output of the simulation tool 320 is a set of waveforms 321, which may be stored in the memory 315. In one embodiment, the net of waveforms 321 includes a single waveform for each net (i.e., signal) specified within the RTL model. In another embodiment, the set of waveforms 321 includes a waveform for a subset of nets specified within the RTL model. The specific subset of nets selected for output may be selected by the designer.

The set of waveforms 321 is processed by the transaction extractor 330. The transaction extractor 330 generates one or more transaction objects 331 that store information about a transaction at a particular interface at a particular point in time. In one embodiment, the transaction objects 331 are data structures that include fields for a transaction identifier (TID), a timestamp, and one or more additional fields. The TID is a unique identifier that may be, e.g., a 32-bit unsigned integer. The TID differentiates the transaction associated with the transaction object 331 from other transactions that are extracted from the set of waveforms 321. The timestamp indicates a time at which the transaction occurred during the simulation. The timestamp may indicate an offset from the start of the simulation, where the start of the simulation is associated with a time 0. The one or more additional fields may include information about the transaction, such as the state of one or more nets included in the interface at the time of the transaction. In one embodiment, the transaction objects 331 are stored in a database that uses the TIDs as keys for storing the transaction objects 331 in the database. In other embodiments, the transaction objects 331 are stored in the database using other fields as the keys. In yet another embodiment, the transaction objects are not stored in a database and each of the transaction objects 331 is referenced by a table or list. Once the transaction extractor 330 has generated the set of transaction objects 331, the transaction objects 331 are passed to the transaction processor 340.

The transaction processor 340 analyzes the set of transaction objects 331 and correlates each of the transaction objects 331 to zero or more other transaction objects 331 that are related. In other words, a particular transaction on one interface may cause a transaction on a second interface at a later point in time during the simulation or may cause a transaction on the same interface at a later point in time during the simulation. For example, a memory request sent from a processing unit to a memory interface at a first time during the simulation may be related to return data sent from the memory interface to the processing unit at a second time during the simulation. In addition, a command received by a processing unit at a first interface may cause the processing unit to send a command to another component in the digital circuit on a second interface. In this case, the two transactions are related, but the original transaction objects 331 generated by the transaction extractor 330 do not include any information that relates one transaction to the other. In one embodiment, the transaction processor 340 uses a series of rules in combination with a persistent state structure to create virtual fields within the transaction objects 331 that correlate related transactions. The virtual fields may also include additional state information that may be useful to a designer when debugging the output of the simulation (e.g., the set of waveforms 321).

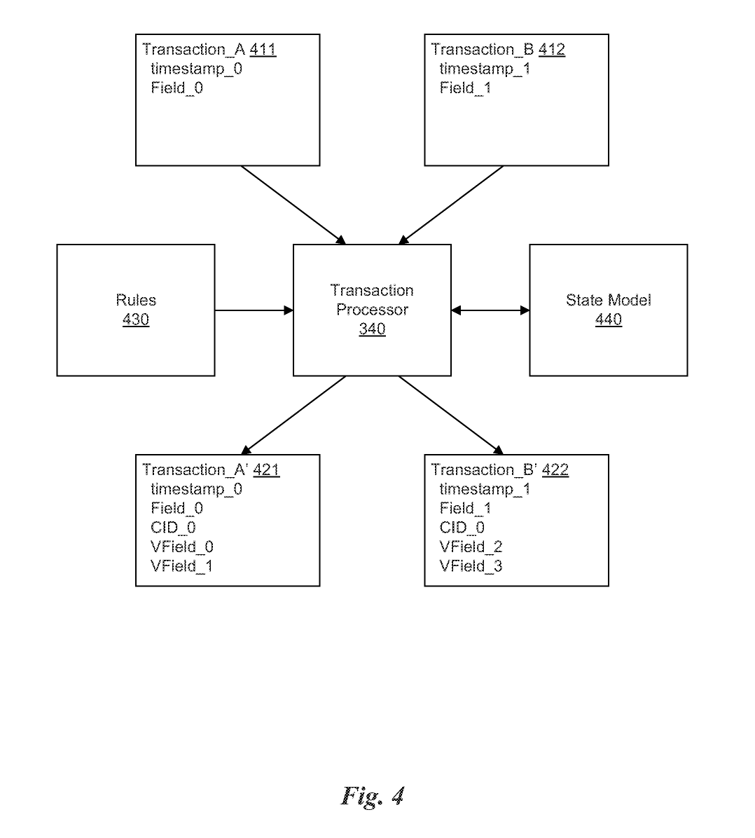

In one embodiment, the transaction processor 340 adds additional fields (i.e., virtual fields) to one or more of the transaction objects 331. At least one of the additional fields includes a correlation identifier (CID), The CID is a unique identifier that may be, e.g., a 32-bit unsigned integer. The transaction processor 340 adds a unique CID to each transaction object 331 associated with one or more related transactions in order to identify the transaction objects as being related. The transaction processor 340 may also add one or more other virtual fields that store state information related to the transactions. The virtual fields added to the transaction objects 331 are discussed in greater detail below in conjunction with FIG. 4. Once the transaction objects 331 have been modified by the transaction processor 340, the modified transaction objects 331 are accessible by the transaction viewer 350 to allow the designer to debug any issues with the RTL model.

The transaction viewer 350 is a program that includes a graphical user interface (GUI) that enables a designer to view the set of waveforms 321 and/or the modified transaction objects 331 associated with a simulation of the RTL model. In one embodiment, a pane on the left side of the application window that implements the GUI includes a list of each of the transaction objects 331. By selecting one of the transaction objects 331 in the pane, the designer may view other transaction objects 331 that are correlated to the selected transaction object 331. A pane on the right side of the application window may display various state data associated with the simulation and/or the selected transaction object 331. For example, the state data may include the contents of RAM, tables, lists, other state structures. RTL signals (e.g., the state of one or more nets at a particular time in the simulation), user specified variables, and the like. In addition, a pane on the bottom of the application window may display one or more of the waveforms 321 from the simulation.

The transaction viewer 350 enables a designer to search the set of transaction objects 331 for fields with particular values, filter the set of transaction objects 331 based on one or more fields, and view the waveforms 321 associated with the transaction objects 331. It will be appreciated that the transaction viewer 350 may be replaced by any type of debugging tool that is configured to use the modified transaction objects 331.

FIG. 4 is a conceptual illustration of the operation of the transaction processor 340 of FIG. 3, in accordance with one embodiment. As shown in FIG. 4, the transaction processor 340 receives a set of transaction objects 331 such as a first transaction object 411 (Transaction_A) and a second transaction object 412 (Transaction_B). The transaction processor 340 also receives a set of rules 430 and a persistent state model 440 associated with the simulation of the RTL model. The transaction processor 340 then uses the set of rules 430 in combination with the state model 440 to generate virtual fields within the modified transaction objects 341, such as the first modified transaction object 421 (Transaction_A′) and the second modified transaction object 422 (Transaction_B′). In one embodiment, the transaction processor 340 generates a new data structure for the modified transaction objects 341, copying the fields from the transaction objects 331 into the corresponding modified transaction objects 341, and adding the new virtual fields to the modified transaction objects 341. In another embodiment, the transaction processor 340 simply adds the virtual fields to the same data structure as the original transaction objects 331, so that the transaction objects 331 are converted into the modified transaction objects 341.

The virtual fields added to the modified transaction objects 341 are functions of the set of rules 430 and/or the state model 440. Each rule in the set of rules 430 may determine whether a virtual field should be added to the modified transaction objects 341. The transaction processor 340 processes each of the currently selected transaction objects 331 based on the rules 430 and the information in the state model 440. A currently selected transaction object 331 may be modified to include a virtual field that is a function of the fields for other transaction objects 331 that have timestamps either before, concurrent with, or after the current transaction object 331.

The state model 440 is a function of all transactions at a prior point in time to the timestamp associated with the current transaction object 331. In other words, the state model 440 stores information about prior transactions in the simulation of the digital circuit. For example, the transaction extractor 330 may have determined that a read request was transmitted at a particular interface in the RTL model. When the transaction processor 340 analyzes that transaction object 331, the state model 440 is configured to save any state information associated with that read request, such as a memory address associated with the read request, a tag associated with the read request, and a timestamp associated with the read request. Therefore, when the transaction processor 340 analyzes a subsequent transaction object 331 associated with a response to the read request, the transaction processor 340 can reference state information in the state model 440 (e.g., information about preceding read requests sent over the interface) and match the response to the corresponding read request.

Again, the state model 440 may be designed based on, at least in part, the RTL model. As such, the structure of the state model 440 may include certain data structures for storing state information in a manner that enables the transaction processor 340 to correlate different transactions. For example, if the RTL model implements in-order memory requests, then the state model 440 may include a FIFO for storing state information about preceding read requests over the memory interface. Thus, for each response received over the memory interface, the transaction processor 340 may correlate the response with the oldest pending read request by selecting the read request from the front of the FIFO. In contrast, if the RTL model implements out-of-order memory requests, then the state model 440 may include a table or list structure for storing state information about preceding read requests. When the transaction processor 340 analyzes a response over the memory interface, the transaction processor 340 may search the data structure for a read request associated with a tag that matches the tag for the response.

In one embodiment, the state model 440 is initialized by the transaction processor 340 to an initial state based on the simulation of the RTL model. The transaction processor 340 orders the transaction objects based on the timestamp in an ascending order. The transaction processor 340 selects the next transaction object 331 from the sorted list having the lowest associated timestamp. The transaction processor 340 updates the state model 440 based on the selected transaction object 331. The transaction processor 340 generates one or more virtual fields for the selected transaction object 331 based on the rules 430 and/or the state model 440. Then, the transaction processor 340 selects the next transaction object 331 in the sorted list and repeats the process to generate virtual fields for that transaction object 331.

In one embodiment, the set of rules 430 may include rules that utilize variables and links. In one embodiment, rules are implemented in a higher-level programming language, so the function that implements a rule can be almost anything that can be implemented within the high-level programming language. Variables are state structures that store information for use in transactions that are associated with timestamps that are later in time. A variable may be used to store state information in the state model 440 that indicates a particular event has occurred. Rules can be programmed that cause transaction objects to be generated conditionally based on the value of the variable. For example, a variable interrupt_fired may be set when an interrupt is fired, and then transaction objects are generated for any read requests generated after the interrupt was fired. Variables may be of different types, such as Boolean values or integers. The variable may be saved directly in a transaction as a virtual field, or may be used to compute one or more virtual fields indirectly. A rule that utilizes a variable may be used to store certain values associated with prior transactions in a virtual field of a second transaction object 331. In the context of the present description, links are state structures that enable the transaction processor 340 to determine a correlation between two or more different transactions. For example, a link may indicate that a read request on a particular interface is correlated to a corresponding response on the interface associated with the same tag. A link structure may be used to store the value of the tag such that the transaction processor 340 can determine which transaction objects 331 are associated with each other (e.g., a memory request may include a tag and a response with return data may also include the tag). In another example, a processor instruction may be marked with a field identifying whether the instruction will eventually commit (i.e., be processed) or when the instruction will write to a register file and the link structure may correlate the initial instruction with the subsequent action based on the instruction.

As discussed above, the transaction processor 340 may generate virtual fields in the modified transaction objects 341. As shown in FIG. 4, the transaction processor 340 has generated three virtual fields in the first modified transaction object 421 (i.e., CID_0, VField_0, and VField_1). The transaction processor 340 has also generated three virtual fields in the second modified transaction object 422 (i.e., CID_0, VField_2, and VField_3). The virtual field holding the value for the CIDs is the same, indicating that the first transaction associated with the first transaction object 411 is correlated with the second transaction associated with the second transaction object 412. However, the other virtual fields added to the modified transaction objects (e.g., 421, 422) are not the same and may include values generated based on different rules or different fields.

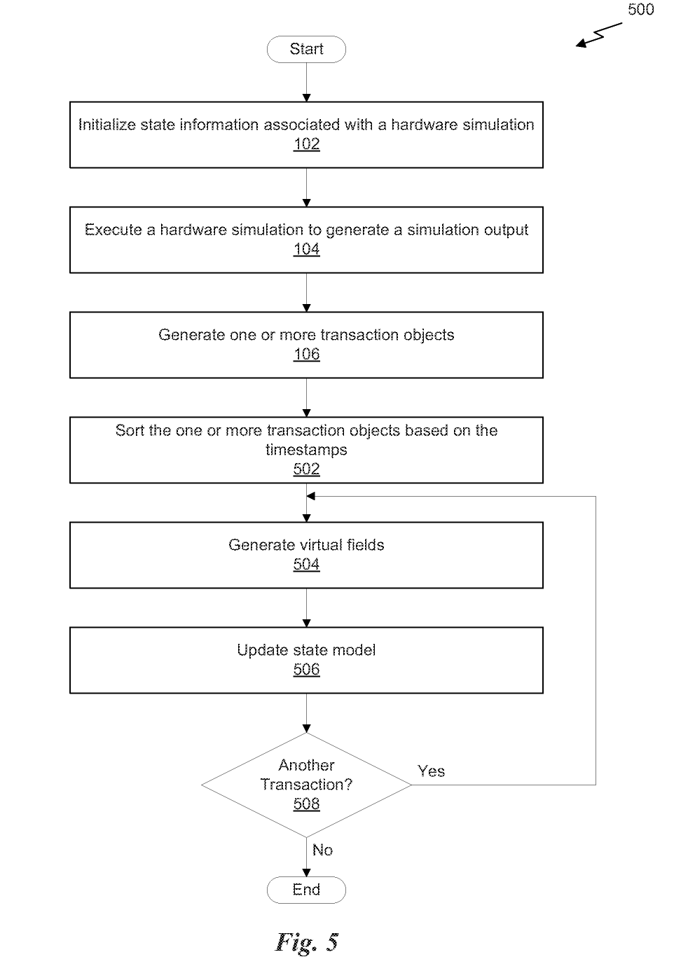

FIG. 5 illustrates a flowchart of a method 500 for correlating transactions within a simulation of a hardware design, in accordance with another embodiment. The method 500 includes the steps 102, 104, and 106 from method 100, described above. After step 106, at step 502, the processor 310 executes the transaction processor 340 to sort the one or more transaction objects 331 based on the timestamps in the transaction objects 331. In one embodiment, the transaction objects 331 are sorted in ascending order from the time 0 during the simulation. At step 504, the transaction processor 340 generates one or more virtual fields. In one embodiment, for each sorted transaction object 331, the transaction processor 340 analyzes the transaction objects to determine if virtual fields should be added to the transaction object. If virtual fields should be added to the transaction object 331, then the transaction processor 340 generates one or more virtual fields that are appended to the transaction object 331. If virtual fields should not be added to the transaction object 331, then the transaction object 331 is not modified.

At step 506, the transaction processor 340 updates the state model. The state model may be updated based on state information associated with the transaction object 331. At step 508, the transaction processor 340 determines whether there are additional sorted transaction objects to process. If so, the method 500 returns to step 504 and the next sorted transaction object 331 is analyzed. However, if there are no further sorted transaction objects 331, then the method 500 is complete.

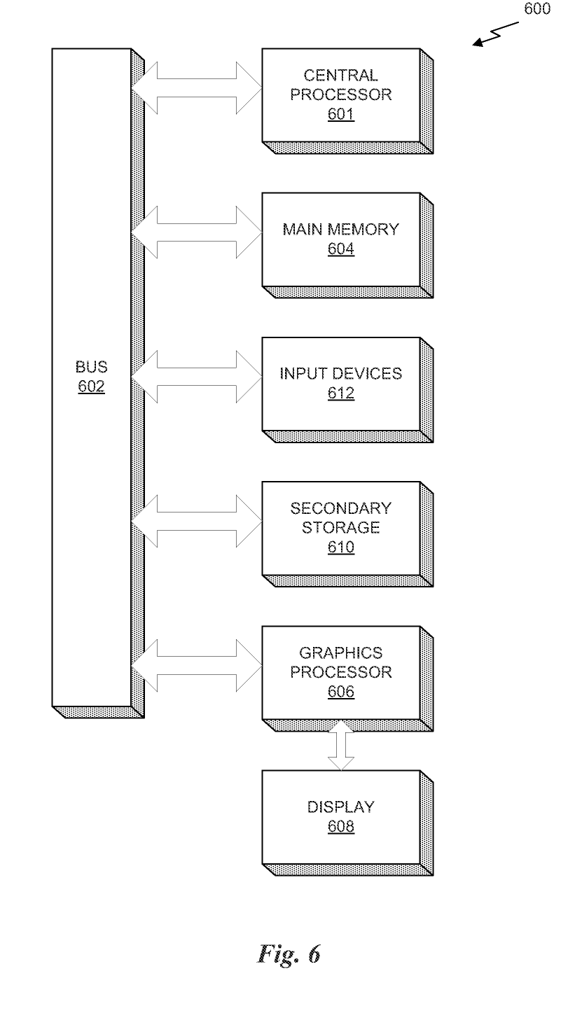

FIG. 6 illustrates an exemplary system 600 in which the various architecture and/or functionality of the various previous embodiments may be implemented. As shown, a system 600 is provided including at least one central processor 601 that is connected to a communication bus 602. The communication bus 602 may be implemented using any suitable protocol, such as PCI (Peripheral Component Interconnect), PCI-Express, AGP (Accelerated Graphics Port), HyperTransport, or any other bus or point-to-point communication protocol(s). The system 600 also includes a main memory 604. Control logic (software) and data are stored in the main memory 604 which may take the form of random access memory (RAM). In one embodiment, the tools 305, such as the transaction processor 340, may be stored in the memory 604 and executed by the processor 601.

The system 600 also includes input devices 612, a graphics processor 606, and a display 608, i.e. a conventional CRT (cathode ray tube), LCD (liquid crystal display), LED (light emitting diode), plasma display or the like. User input may be received from the input devices 612, e.g., keyboard, mouse, touchpad, microphone, and the like. In one embodiment, the graphics processor 606 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 600 may also include a secondary storage 610. The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 604 and/or the secondary storage 610. Such computer programs, when executed, enable the system 600 to perform various functions. The memory 604, the storage 610, and/or any other storage are possible examples of computer-readable media.

In one embodiment, the architecture and/or functionality of the various previous figures may be implemented in the context of the central processor 601, the graphics processor 606, an integrated circuit (not shown) that is capable of at least a portion of the capabilities of both the central processor 601 and the graphics processor 606, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 600 may take the form of a desktop computer, laptop computer, server, workstation, game consoles, embedded system, and/or any other type of logic. Still yet, the system 600 may take the form of various other devices including, but not limited to a personal digital assistant (PDA) device, a mobile phone device, a television, etc.

Further, while not shown, the system 600 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
initializing state information associated with a hardware simulation for a register-transfer level (RTL) model representing a digital circuit design;
executing the hardware simulation to generate a simulation output;
generating one or more transaction objects based on the simulation output; and
correlating a first transaction object of the one or more transaction objects with a second transaction object of the one or more transaction objects based on a set of rules and a state model.

2. The method of claim 1, wherein the simulation output comprises a set of waveforms corresponding to one or more nets in the RTL model.

3. The method of claim 1, wherein correlating the first transaction object with the second transaction object comprises generating a virtual field that includes a correlation identifier within both the first transaction object and the second transaction object.

4. The method of claim 3, wherein the correlation identifier is an unsigned 32-bit integer.

5. The method of claim 3, further comprising generating a second virtual field in either the first transaction object or the second transaction object, wherein the second virtual field includes a value that is a function of at least one rule in the set of rules and the state model.

6. The method of claim 1, wherein each transaction object includes a time stamp that indicates a time an associated transaction was initiated during the hardware simulation.

7. The method of claim 1, wherein at least one rule in the set of rules utilizes a variable that references state information stored in the state model.

8. The method of claim 1, wherein at least one rule in the set of rules utilizes a link that includes a set of conditions that indicate whether a transaction on one interface is related to a transaction on another interface.

9. The method of claim 1, further comprising displaying at least a portion of the one or more transaction objects in a transaction viewer tool.

10. The method of claim 9, further comprising filtering the at least a portion of the one or more transaction objects in the transaction viewer tool based on a field within the transaction objects.

11. The method of claim 1, further comprising:
sorting the one or more transaction objects based on timestamps that are included in each transaction object; and
for each sorted transaction object, in ascending order based on the timestamps:
analyzing the transaction object to determine if virtual fields should be added to the transaction object,
if virtual fields should be added to the transaction object, then generating one or more virtual fields that are appended to the transaction object, and
updating the state model based on the transaction object.

12. The method of claim 11, wherein at least one virtual field includes a value based on a function of at least one rule in the set of rules and at least a portion of the state model.

13. A non-transitory computer-readable storage medium storing instructions that, when executed by a processor, cause the processor to perform steps comprising:
initializing state information associated with a hardware simulation for a register-transfer level (RTL) model representing a digital circuit design;
executing the hardware simulation to generate a simulation output;
generating one or more transaction objects based on the simulation output; and
correlating a first transaction object of the one or more transaction objects with a second transaction object of the one or more transaction objects based on a set of rules and a state model.

14. The non-transitory computer-readable storage medium of claim 13, wherein correlating the first transaction object with the second transaction object comprises generating a virtual field that includes a correlation identifier within both the first transaction object and the second transaction object.

15. The non-transitory computer-readable storage medium of claim 14, the steps further comprising generating a second virtual field in either the first transaction object or the second transaction object, wherein the second virtual field includes a value that is a function of at least one rule in the set of rules and at least a portion of the state model.

16. The non-transitory computer-readable storage medium of claim 3, the steps further comprising:
sorting the one or more transaction objects based on timestamps that are included in each transaction object; and
for each sorted transaction object, in ascending order based on the timestamps:
analyzing the transaction object to determine if virtual fields should be added to the transaction object,
if virtual fields should be added to the transaction object, then generating one or more virtual fields that are appended to the transaction object, and
updating the state model based on the transaction object.

17. A system, comprising:
a memory storing one or more programs; and
a processor coupled to the memory and configured to execute the one or more programs to:
initialize state information associated with a hardware simulation for a register-transfer level (RTL) model representing a digital circuit design;
execute the hardware simulation to generate a simulation output;
generate one or more transaction objects based on the simulation output; and
correlate a first transaction object of the one or more transaction objects with a second transaction object of the one or more transaction objects based on a set of rules and a state model.

18. The system of claim 17, wherein the one or more programs include a simulation tool configured to generate the simulation output, a transaction extractor tool configured to generate the one or more transaction objects, and a transaction processor tool configured to correlate the first transaction object with the second transaction object.

19. The system of claim 17, wherein correlating the first transaction object with the second transaction object comprises generating a virtual field that includes a correlation identifier within both the first transaction object and the second transaction object.

20. The system of claim 19, the processor further configured to generate a second virtual field in either the first transaction object or the second transaction object, wherein the second virtual field includes a value that is a function of at least one rule in the set of rules and at least a portion of the state model.
